(19) United States
(12) Patent Application Publication
(10) Pub. No.: US 2025/0374981 A1
(43) Pub. Date: Dec. 11, 2025

(54) MAGNETIC SUCTION TYPE WAIST BELT BUCKLE THAT CAN BE QUICKLY CLAMPED

(71) Applicant: LIMING CHEN, Wuchuan (CN)

(72) Inventor: LIMING CHEN, Wuchuan (CN)

(21) Appl. No.: 18/800,627

(22) Filed: Aug. 12, 2024

(30) Foreign Application Priority Data
Jun. 7, 2024 (CN) 202421307699.1

(51) Int. Cl. A41F 9/00; H01F 7/02

(52) U.S. Cl. CPC A41F 9/002; H01F 7/0263

(57) ABSTRACT

A magnetic suction type waist belt buckle that can be quickly clamped is provided; a first fitting surface is formed on a male buckle. The first fitting surface is provided with a first installation groove, and the first installation groove is provided with a first magnetic suction structure; one side of the first fitting surface is provided with a tilted male buckle limit side plate; a second fitting surface is formed on a female buckle; one side of the second fitting surface is provided with an inclined female buckle limit side plate. The second fitting surface is provided with a second installation groove, the second installation groove is provided with a second magnetic suction structure; a waist belt clamping part is provided at a tail end of the male buckle, and a waist belt cavity is formed between the waist belt clamping part and the male buckle.

### CROSS-REFERENCE TO RELATED APPLICATIONS

This application claims priority to Chinese Patent Application No. 202421307699.1, filed on Jun. 7, 2024, which is hereby incorporated by reference in its entirety.

### TECHNICAL FIELD

The present disclosure relates to the field of waits belt buckle technologies, and in particular, to a magnetic suction type waist belt buckle that can be quickly clamped.

### BACKGROUND

In daily life, waist belts, also known as belts, are divided into genuine leather belts and artificial belts according to their materials. They are extremely common clothing accessories and also have a fixing effect to prevent pants from falling off. A waist buckle is a control accessory at a front end of the waist belt, used to decorate and fix the entire waist belt. The waist belt buckle refers to a hardware accessory at the front end of the waist belt.

However, the existing waist belt buckles mostly adopt male and female buckle that are insertion structure, which not only renders it difficult to quickly align and fasten, but also has low strength after insertion, rendering it easy to relax during use. For this purpose, a magnetic suction type waist belt buckle that can be quickly clamped is provided to overcome the above problems.

### SUMMARY

The purpose of the present disclosure is to provide a magnetic suction type waist belt buckle that can be quickly clamped for the above-mentioned shortcomings in existing technology, which is used to solve the problem that the existing waist belt buckle mostly adopts a male buckle and a female buckle that are insertion structures. Which is not only difficult to quickly align the buckle, but the strength after insertion is low, it is prone to looseness during use.

The technical solution adopted by the present disclosure to achieve the above objectives is a magnetic suction type waist belt buckle that can be quickly clamped, including a male buckle, a female buckle, and a waist belt clamping part,
a first fitting surface is formed on the male buckle;
the first fitting surface is provided with a first installation groove, and the first installation groove is provided with a first magnetic suction structure;
one side of the first fitting surface is provided with an inclined male buckle limit side plate;
a second fitting surface is formed on the female buckle;
one side of the second fitting surface is provided with an inclined female buckle limit side plate;
the second fitting surface is provided with a second installation groove, and the second installation groove is provided with a second magnetic suction structure;
   the waist belt clamping part is provided at a tail end of the male buckle, and a waist belt cavity configured for a fixed waist belt body to pass through is formed between the waist belt clamping part and the male buckle; the waist belt clamping part is detachably connected to the male buckle through a fastener.

In an embodiment of the present disclosure, a first buckle is provided between the male buckle and the female buckle, and the first buckle includes a first clamp slot and a second hook, one of which is provided on the male buckle and the other is provided on the female buckle.

In an embodiment of the present disclosure, a second buckle is further provided between the male buckle and the female buckle, and the second buckle includes a first hook and a second slot, one of which is provided on the male buckle and the other is provided on the female buckle.

In an embodiment of the present disclosure, a hole channel is provided on the waist belt cavity configured to connect the fastener.

In an embodiment of the present disclosure, the waist belt clamping part is a “I”-shaped long tube, and the waist belt clamping part is connected to positioning blocks at both ends along its length direction, and a connection hole is respectively provided on two positioning blocks.

In an embodiment of the present disclosure, the connection hole is assembled and aligned coaxially with the hole channel.

In an embodiment of the present disclosure, a tail end of the male buckle is further provided with a wait belt threading groove configured for the waist belt body to pass through.

In an embodiment of the present disclosure, a bottom of the female buckle is provided with a plurality of fixing holes configured to position the waist belt.

In an embodiment of the present disclosure, the first fitting surface is adapted and adhered to the second fitting surface.

In an embodiment of the present disclosure, the male buckle limit side plate abuts against the female buckle limit side plate.

The beneficial effects of the present disclosure:
(1) this magnetic suction type waist belt buckle that can be quickly clamped uses male and female buckles that are inserted, rendering it easy to fasten and align. The magnetic suction structure can then quickly and accurately fasten the waist belt buckle.
(2) this magnetic suction type waist belt buckle is fastened by the magnetic suction structure, and then further fastened and fixed by two sets of fasteners, ensuring a firm fastening and preventing accidental release due to misoperation, thereby improving stability.

### BRIEF DESCRIPTION OF DRAWINGS

FIG. 1 is a schematic diagram of a top view of the present disclosure.

FIG. 2 is an exploded structural view in a top view of FIG. 1.

FIG. 3 is a schematic structural diagram in an upward view of the present disclosure.

FIG. 4 is an exploded structural diagram in a top-down view of FIG. 3.

FIG. 5 is an installation schematic structural diagram of a waist belt and a decorative panel in the present disclosure.

FIG. 6 is installation schematic structural diagram of the waist belt and a Bluetooth speaker in the present disclosure

Numeral reference: 1 male buckle, 11 first clamp slot, 12 first fitting surface, 13 male buckle limit side plate, 14 first installation groove, 15 first hook, 16 waist belt cavity, 17 wait belt threading groove, 18 hole channel, 2 female buckle, 21 second slot, 22 fixing hole, 23 second fitting surface, 24 female buckle limit side plate, 25 second installation groove, 26 second hook, 3 waist belt clamping part, 31 positioning block, 311 connection hole, 4 first magnetic suction structure, 5 second magnetic suction structure, 6 fastener, 7 decorative plate, 8 waist belt, 9 Bluetooth speaker.

### DESCRIPTION OF EMBODIMENTS

The following will provide a clear and complete description of the technical solution in the embodiments of the present disclosure, in combination with the accompanying drawings. Obviously, the described embodiments are only a part of the embodiments of the present disclosure, not all of them. Based on the embodiments in the present disclosure, all other embodiments obtained by those skilled in the art without creative work fall within the protection scope of the present disclosure.

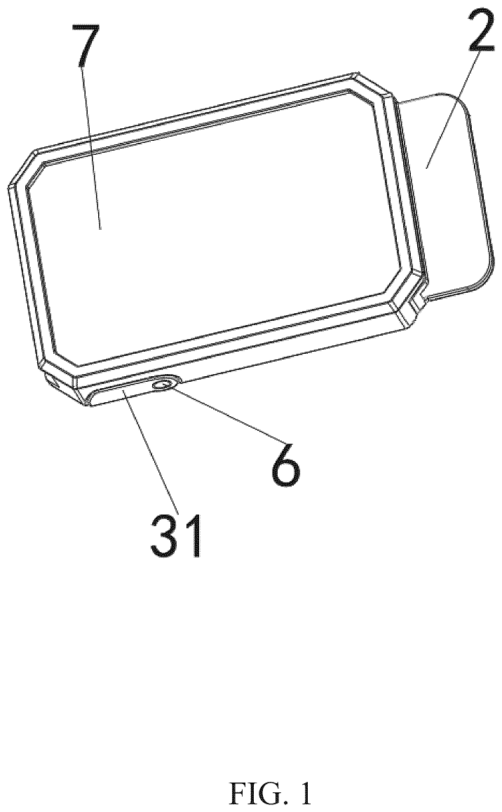

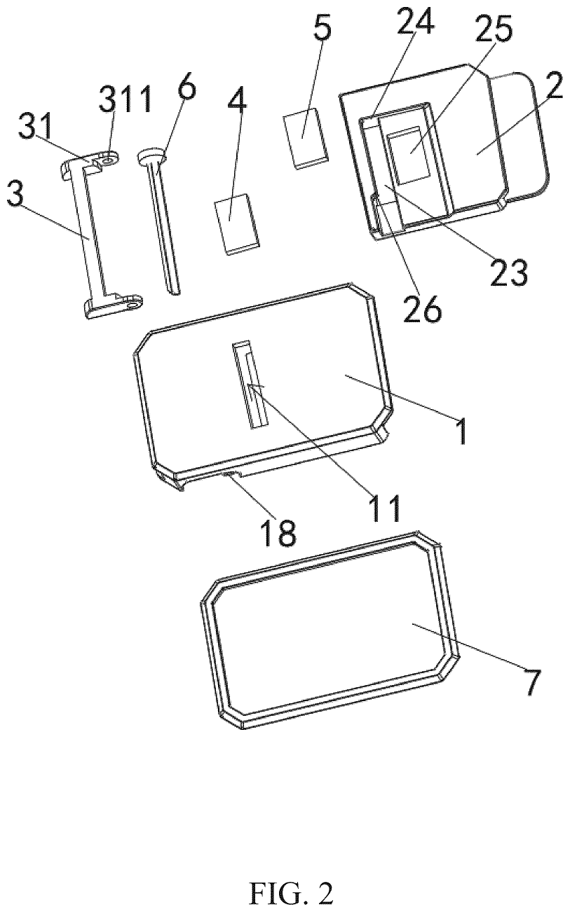

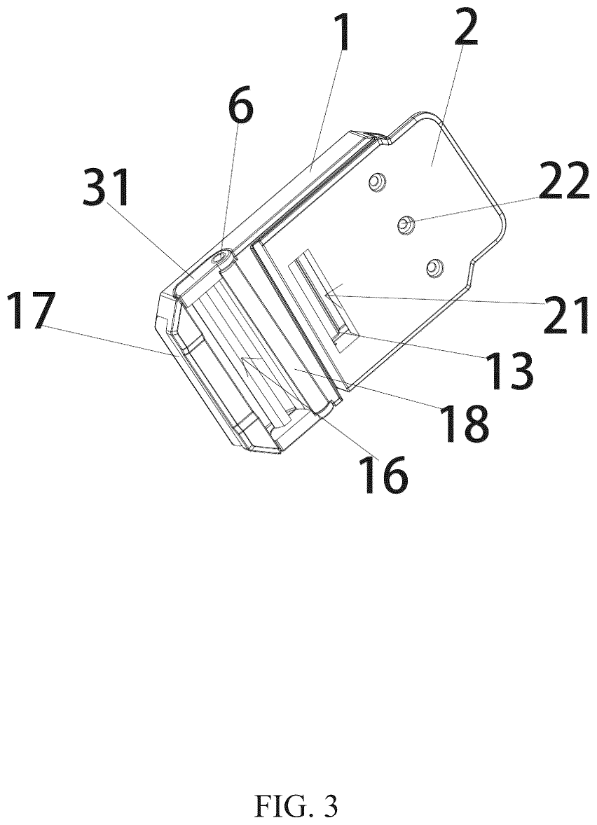

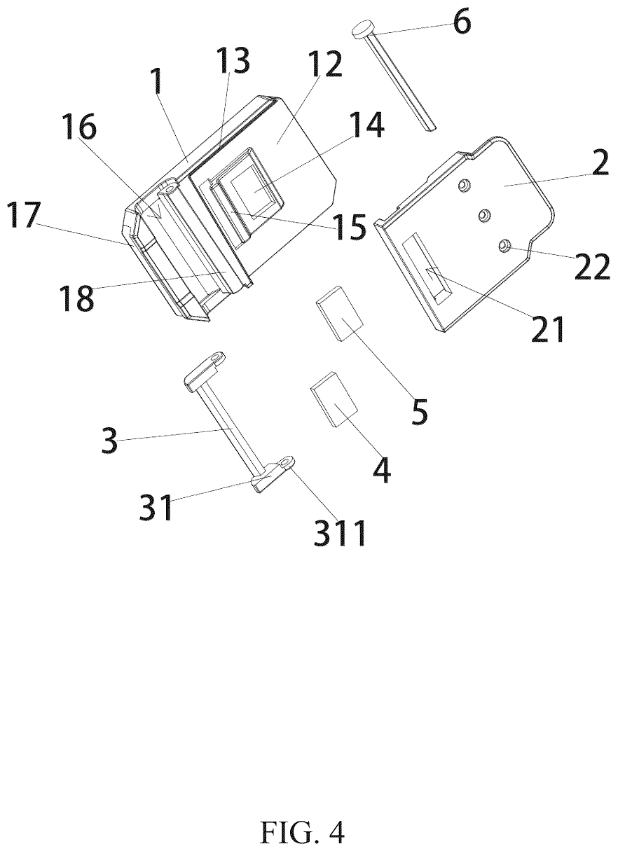

Please refer to FIGS. 1 to 4. The present disclosure relates to a magnetic suction type waist belt buckle that can be quickly clamped, including a male buckle 1, a female buckle 2, and a waist belt clamping part 3.

A first fitting surface 12 is formed on the male buckle 1, one side of the first fitting surface 12 is further provided with an inclined male buckle limit side plate 13. A second fitting surface 23 is formed on the female buckle 2, and one side of the second fitting surface 23 is further provided with an inclined female buckle limit side plate 24. The first fitting surface 12 is adapted and adhered to the second fitting surface 23. The male buckle limit side plate 13 abuts against the female buckle limit side plate 24.

The first fitting surface 12 is provided with a first installation groove 14, which is provided with a first magnetic suction structure 4. The second fitting surface 23 is provided with a second installation groove 25, which is provided with a second magnetic suction structure 5. The waist belt clamping part 3 is provided at a tail end of the male buckle 1, and a waist belt cavity 16 configured for a fixed waist belt body to pass through is formed between the waist belt clamping part 3 and the male buckle 1. The waist belt clamping part 3 is detachably connected to the male buckle 1 through a fastener 6. By tilting and matching the male buckle limit side plate 13 and the female buckle limit side plate 24, the two can be aligned in an oblique insertion manner. A user can operate with one hand, and a magnetic adsorption can be generated between the male buckle 1 and the female buckle 2, thereby quickly and accurately completing a buckle connection between the male buckle 1 and the female buckle 2.

A first buckle is provided between the male buckle 1 and the female buckle 2, and the first buckle includes a first clamp slot 11 and a second hook 26, one of which is provided on the male buckle 1 and the other is provided on the female buckle 2; a second buckle is provided between the male buckle 1 and the female buckle 2, the second buckle includes a first hook 15 and a second slot 21, one of which is provided on the male buckle 1 and the other is provided on the female buckle 2. A connection strength between the male buckle 1 and the female buckle 2 can be improved by using two sets of fasteners to prevent the waist belt from falling off.

The waist belt cavity 16 is provided with a hole channel 18 configured to connect the fastener 6. The waist belt clamping part 3 is a “I”-shaped long tube, and positioning blocks 31 are connected at both ends along its length direction. A connection hole 311 is respectively provided on two positioning blocks 31, and the waist belt ends with different lengths can be clamped through the waist belt clamping part 3. When it is necessary to change a suitable length of the waist belt, the waist belt end can be adjusted and fixed to the waist belt cavity 16 through the waist belt clamping part 3 to achieve the adjustment of the waist belts with different lengths and the length is fixed after adjustment. The connection hole 311 is assembled and aligned coaxially with the hole channel 18, so that the fastener 6 (which is a fixed position nail) can penetrate the connection hole 311 and the hole channel 18, thereby fixing the waist belt clamping part 3 on the male buckle 1.

A tail end of the male buckle 1 is further provided with a wait belt threading groove 17, which allows the waist belt body to pass through, so that the waist belt clamping part 3 can adjust the length of the belt and position it for use.

A bottom of the female buckle 2 is provided with a plurality of fixing holes 22, which are threaded through the fixing holes 22 (not shown in the figure) to position the waist belt 8 for fixing the waist belt.

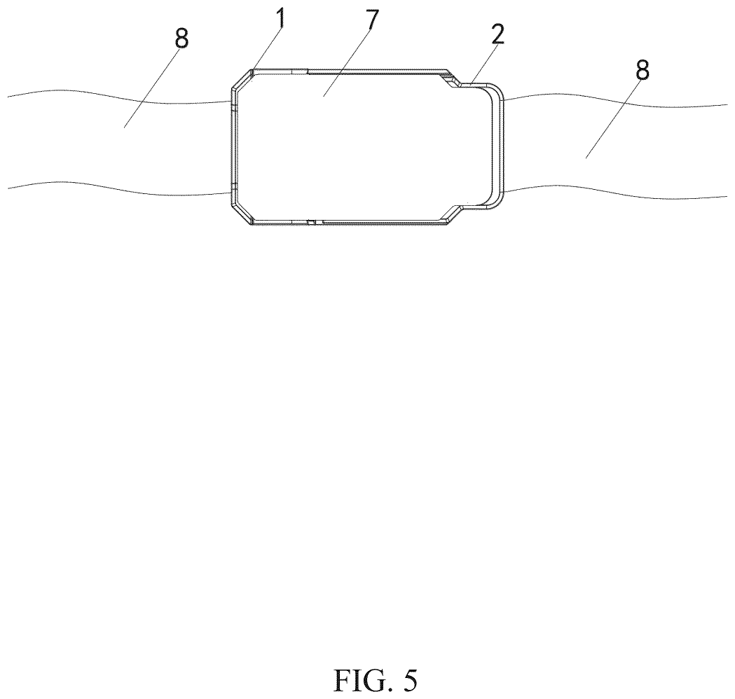

In an embodiment: please refer to FIG. 5. The tail end of the male buckle 1 is connected to one end of the waist belt 8 through the wait belt threading groove 17, and then fixed to the other end of the waist belt 8 at the female buckle 2 through a threaded nail (not shown in the figure) through the fixing hole 22. Additionally, a decorative plate 7 can be installed on the waist belt buckle to maintain its beauty and durability.

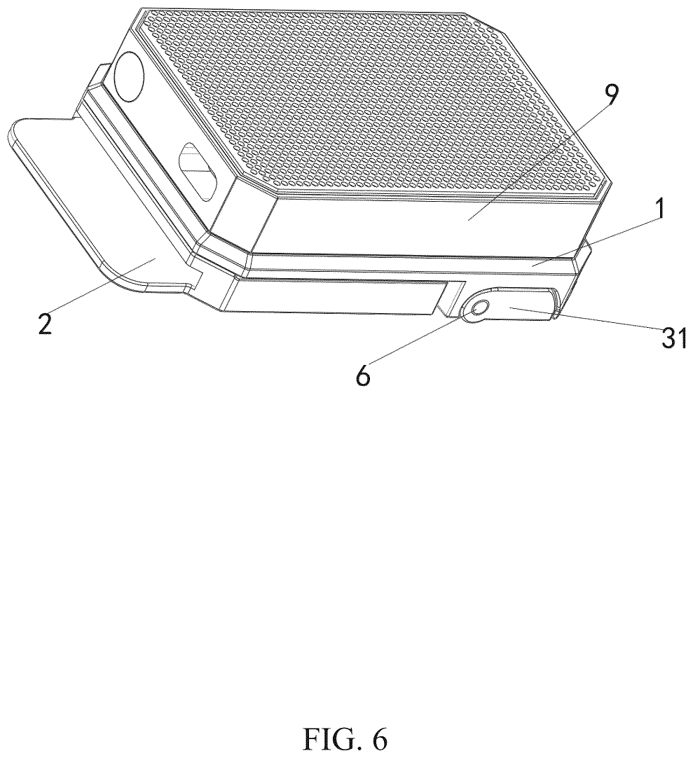

In an embodiment: please refer to FIG. 6. A Bluetooth speaker 9 can also be magnetically installed on the waist belt (when there is no decorative plate 7) using magnets (which can be made of samarium cobalt magnets, neodymium iron boron magnets (strong magnets), ferrite magnets, aluminum nickel cobalt magnets, iron chromium cobalt magnets and other square magnet structures). Magnetic installation of the Bluetooth speaker 9 using magnets can improve installation efficiency and facilitate disassembly and replacement, improving convenience of use. Furthermore, the Bluetooth speaker 9 refers to audio devices with built-in Bluetooth chips that replace traditional wired connections with Bluetooth connections. By connecting with Bluetooth playback devices such as mobile phones, tablets, and laptops, it achieves convenience. The Bluetooth speaker 9 in the present application is mainly a portable speaker, which is generally compact and portable. It can be used as a single channel speaker (single speaker unit) or a multi-channel speaker with excellent sound quality (two or more speaker units) commonly seen in the market.

The standard parts used in the present disclosure can be purchased from the market, and the irregular parts can be customized according to the description in the specification and the accompanying drawings. The specific connection manners of each part are conventional manners such as a bolt, rivet, and welding that are mature in the existing technology. The machinery, parts, and equipment all use the conventional models in the existing technology, and the circuit connection adopts the conventional connection methods in the existing technology. This will not be elaborated here. The content not described in detail in this specification belongs to the existing technology well-known to those skilled in the art.

In addition, it should be understood that although this specification is described according to the embodiment, not each embodiment only includes an independent technical solution. The description in the specification is for clarity only. Those skilled in the art should treat the specification as a whole, and the technical solutions in each embodiment can be appropriately combined to form other embodiments that those skilled in the art can understand.

What is claimed is:

1. A magnetic suction type waist belt buckle that can be quickly clamped, comprising a male buckle, a female buckle, and a waist belt clamping part,
a first fitting surface is formed on the male buckle;
the first fitting surface is provided with a first installation groove, and the first installation groove is provided with a first magnetic suction structure;
one side of the first fitting surface is provided with an inclined male buckle limit side plate;
a second fitting surface is formed on the female buckle;
one side of the second fitting surface is provided with an inclined female buckle limit side plate;
the second fitting surface is provided with a second installation groove, and the second installation groove is provided with a second magnetic suction structure;
the waist belt clamping part is provided at a tail end of the male buckle, and a waist belt cavity configured for a fixed waist belt body to pass through is formed between the waist belt clamping part and the male buckle; the waist belt clamping part is detachably connected to the male buckle through a fastener.

2. The magnetic suction type waist belt buckle according to claim 1, wherein a first buckle is provided between the male buckle and the female buckle, and the first buckle comprises a first clamp slot and a second hook, one of which is provided on the male buckle and the other is provided on the female buckle.

3. The magnetic suction type waist belt buckle according to claim 1, wherein a second buckle is further provided between the male buckle and the female buckle, and the second buckle comprises a first hook and a second slot, one of which is provided on the male buckle and the other is provided on the female buckle.

4. The magnetic suction type waist belt buckle according to claim 1, wherein a hole channel is provided on the waist belt cavity configured to connect the fastener.

5. The magnetic suction type waist belt buckle according to claim 4, wherein the waist belt clamping part is a “I”-shaped long tube, and the waist belt clamping part is connected to positioning blocks at both ends along its length direction, and a connection hole is respectively provided on two positioning blocks.

6. The magnetic suction type waist belt buckle according to claim 5, wherein the connection hole is assembled and aligned coaxially with the hole channel.

7. The magnetic suction type waist belt buckle according to claim 1, wherein a tail end of the male buckle is further provided with a wait belt threading groove configured for the waist belt body to pass through.

8. The magnetic suction type waist belt buckle according to claim 1, wherein a bottom of the female buckle is provided with a plurality of fixing holes configured to position the waist belt.

9. The magnetic suction type waist belt buckle according to claim 1, wherein the first fitting surface is adapted and adhered to the second fitting surface.

10. The magnetic suction type waist belt buckle according to claim 1, wherein the male buckle limit side plate abuts against the female buckle limit side plate.
